(19) United States
(12) Patent Application Publication
(10) Pub. No.: US 2026/0120079 A1
(43) Pub. Date: Apr. 30, 2026

(54) Transaction Intelligence

(71) Applicant: RedOwl Pty Ltd, Richmond (AU)

(72) Inventors: Indrajit Solomon Arulampalam, Blackburn (AU); Thushan Shanmugarajah, Blackburn South (AU)

(73) Assignee: RedOwl Pty Ltd, Richmond (AU)

(21) Appl. No.: 19/374,617

(22) Filed: Oct. 30, 2025

(30) Foreign Application Priority Data
Oct. 31, 2024 (AU) 2024903546

(51) Int. Cl. G06Q 20/34; G06Q 20/22; G06Q 20/40

(52) U.S. Cl. CPC G06Q 20/3572; G06Q 20/227; G06Q 20/401

(57) ABSTRACT

One or more embodiments of the present disclosure relate to methods for managing transactions using Pre-Transactional Intelligence (PTI) comprising generating pre-authorised spend tokens (e.g., from user or AI-inferred spend intent), comparing transaction parameters against these tokens, and routing approved transactions to virtual funding accounts (VFA) in real-time, thereby enabling intent-driven, policy-compliant authorization within existing payment rails.

### RELATED APPLICATIONS

This application claims priority from Australian Patent Application No. 2024903546 filed on 31 Oct. 2024, the entire disclosure of which is expressly incorporated herein by reference.

### TECHNICAL FIELD

The present disclosure generally relates to transaction management. More particularly, embodiments of the present disclosure relate to routing a transaction to one of a plurality of funding sources for managing the transaction.

### BACKGROUND

Card systems for payment were originally designed for when a person spending using the card and a funder of the card are the same, and it was assumed that the person is spending their own funds purely at their own discretion, and all transactions were one-time transactions.

However, with the proliferation of cards as a convenient, safe and widely accepted payment instrument, there has emerged a new segment of use cases where the spender using the card to make a payment or spend, and the funder are two different persons/entities. This meant that one entity (funder) was funding the card and another entity (spender) was using said card to make spends, and often these two may not be aligned.

In a corporate scenario, the spender may be an employee who has the ability to spend money of the company, employer or organization (funder) to further the business goals of the company, employer or organization through the use of corporate cards/payment cards. However, current methods and/or systems lack the ability to determine if the spend is in fact related to a specific business goal. Corporate Spend Policies and approval systems may give the employees a guideline on spending but enforcing these can become cumbersome. In this case, the funder is the company, employer or organization, and the spender is the employee.

In a financing scenario, banks/creditors/financiers/lenders may provide credit facilities to finance businesses such as small to medium sized businesses (SMEs), to spend on pre-agreed uses of the funds, such as, but not limited to, procuring goods for sale, investing in machinery etc. However, existing cards may be unable to determine if the SME owner/management is using the credit facilities in line with the financier's expectation. In this case, the funder may be the financier/bank/lender, and the spender may be the SME owner/management.

In a government welfare disbursement scenario, government agencies may issue a type of card with a fixed sum of money to its beneficiaries to spend on essential goods and/or services. However, at the time of spend, the funding agency may be unable to ascertain if the beneficiary is spending on an allowed item or not. In this case, the funder may be the government agency and the spender may be the welfare beneficiary.

In a consumer spending scenario, an adult/carer/parent/guardian may issue a card to a child or a home help (e.g., a nanny, chauffeur etc.) as an allowance or for approved expenses. However, the child or the help may buy items/spend on goods and/or services that the adult/carer/parent/guardian may not have wanted them to. In this case, the funder may be the adult/carer/parent/guardian, and the spender may be the child or the help.

In fleet management scenario, fuel cards have traditionally been issued to employees such as drivers for the exclusive purpose of managing and limiting fuel expenditure. These cards are typically configured to allow transactions only at Merchant Category Codes (MCC) associated with fuel stations. However, in practice, fuel stations often sell a range of non-fuel goods and services-such as food, beverages, or convenience items-under the same MCC classification. Consequently, a spender (e.g., a driver) may use such cards for non-fuel purchases that nonetheless pass through the payment network as valid fuel transactions. Existing card systems are unable to determine the context of such spends in real time, forcing organizations to rely on post-transaction invoice reviews and manual reconciliation to detect policy breaches. This reactive approach may lack precision and/or control at the point of spend.

In conventional finance operations, invoices and quotations are often processed manually, with limited pre-authorization control. Employees or finance administrators typically verify details after the expense has occurred, resulting in delayed compliance, inconsistent reporting, and limited visibility into organizational spending.

These are some examples (not exhaustive) of scenarios where the funder and the spender are two different persons/entities and as a result, the spender's spend intent may not align with funder's spend policy.

Existing card networks that may employ virtual card frameworks achieve transaction-specific control by issuing a card associated with a unique card number (e.g., Primary Account Number (PAN)) per transaction, supplier, and/or spending rule. Although such framework may be effective for security and/or reconciliation, such frameworks are limited by their static nature (i.e., tied to the specific transaction, supplier and/or spending rule) and/or dependent on repeated credential issuance.

When a transaction authorization request reaches the issuer, the decision to approve or decline is made using fixed parameters, including available balance, merchant category code (MCC), and/or issuer rules. The underlying payment rail remains one-dimensional—each card maps to a single funding source, and contextual data such as user intent or business justification is not considered at the authorization stage.

Further, issuers and/or networks may operate fraud management engines (e.g., at the authorization layer) in parallel with authorisation engines. Such systems or methods may analyse transaction data using blacklist-based logic to detect anomalies or suspicious patterns. Fraud engines are reactive and rely on aggregated behavioral data but lack localized intelligence and/or direct awareness of the spender's legitimate intent.

Consequently, while fraud detection systems/methods may protect the network from unauthorized activity, such systems/methods can neither ensure that an approved transaction aligns with the funder's spending policy or purpose, nor can existing virtual card systems or fraud engines dynamically route a transaction to multiple potential funding sources based on pre-transactional context.

Current cards/payment cards are one-dimensional i.e., a transaction made using the card is approved or declined based on whether or not there are sufficient funds available in the single designated funding account or funding source to which the card is associated. Such a one-dimensional transaction approval method and/or system does not take into consideration factors such as funder's policy or context of a given spend.

Accordingly, even if a funder imposes designated limits for one or more categories in the single funding source or funding account by way of budgets or spend rules, current solutions are unable to route the transactions between multiple funding sources in real-time.

Payment networks use a standard card numbering system which includes one or more digits representing a card network, an issuing bank identifier, a card identifier and a checksum verifier digit for verifying that there are no errors. The card identifier in the card number corresponds to a single bank account of the payment card user/customer (spender) of the issuing bank. Accordingly, the current card infrastructure used by payment networks allows a single payment card to only be able to represent a single bank account and to route a transaction made by that card to that specific account. Further, merchants are able to input limited details e.g., transaction value, when a payment card is presented at the payment terminal according to the existing payment infrastructure.

It is desired to address or alleviate one or more disadvantages or limitations of the prior art, or to at least provide a useful alternative.

### SUMMARY

According to an aspect, there is provided a method of managing a transaction, the method comprising: receiving a transaction request from a user for a transaction; determining one or more transaction parameters based on the received transaction request; and routing the transaction to one of a plurality of funding sources based on a match between the determined one or more transaction parameters and one or more spend intents of the user.

Each of the one or more spend intents may be a request or suggestion for a transaction submitted by the user prior to submitting the transaction request.

Routing the transaction to one of a plurality of funding sources based on the match between the determined one or more transaction parameters and one or more spend intents of the user may further comprise determining one or more spend intent parameters of each of the one or more spend intents submitted by the user.

An account parameter set corresponding to each of the one or more spend intents may be generated in response to the determined one or more spend intent parameters satisfying an approval condition.

For each generated account parameter set, a funding source may be created.

Each of the one or more spend intents may be submitted as an unstructured data by the user.

In an embodiment, the unstructured data may be converted into structured data corresponding to the one or more transaction parameters associated with the transaction for determining the one or more spend intent parameters.

The one or more transaction parameters may comprise any one of: transaction value, applicable taxes, bank charges, payment network charges, merchant identity (merchant name, merchant identity number), merchant category code, location code, currency in which the payment was made, transaction value in native currency, time, date, terminal ID, terminal type, Invoice ID, Purchase Order ID, Product code, Product specification.

In an embodiment, a number of the plurality of funding sources may be dynamically created, modified or deleted based on the one or more spend intents.

The transaction request may be made by the user using a payment card.

The payment card may be associated with each of the plurality of funding sources.

The match may be based on a weightage assigned to one or both of the user, funder.

In an embodiment, the weightage may be dynamically updated.

The transaction may be routed to another one of the plurality of funding sources based on the match between the determined one or more transaction parameters and one or more spend intents of the user.

In an embodiment, a spend token may be generated, representing a pre-authorized payment equal to at least one of the one or more spend intent parameters of each of the one or more spend intents submitted by the user and satisfying an approval condition.

In an embodiment, a spend token may be generated and mapped to at least one of the plurality of funding sources linked to the payment card.

The spend token may be configured to be active for a predetermined period of time.

A post-spend verification may be performed randomly or at predetermined intervals to maintain continuous compliance integrity.

In an embodiment, autonomous pre-authorization may be performed wherein a spend token is generated based on a spend intent input by the user, without requiring policy validation.

Upon initiation of the transaction request at a point of sale, the transaction may be approved and routed to one of the plurality of funding courses based on a match between one or more of the transaction parameters and the spend token.

### BRIEF DESCRIPTION OF THE DRAWINGS

One or more embodiments of the present invention are hereinafter described, by way of example only, with reference to the accompanying drawings in which:

FIG. 1A, 1B is a prior art method of managing transactions;

FIG. 2 is a flow diagram of a method of managing a transaction according to an embodiment of the present disclosure;

FIGS. 3A, 3B in combination show a method of managing a transaction according to another embodiment of the disclosure;

FIGS. 4A, 4B in combination show a detailed method of managing a transaction according to another embodiment of the disclosure;

FIG. 5 is a flow diagram of a method of managing a transaction according to an embodiment of the present disclosure; and

FIG. 6 is an exemplary post-decline asynchronous remediation workflow according to an embodiment of the present disclosure.

### DETAILED DESCRIPTION

One or more embodiments of the present disclosure relates to transaction authorisation and management methods and systems. More particularly, various embodiments of the present disclosure relate to a pre-transactional intelligence framework that performs contextual authorization by generating and validating spend tokens prior to transaction execution, thereby enabling transaction-level control rather than card-level control, and avoiding need to issue new card credentials.

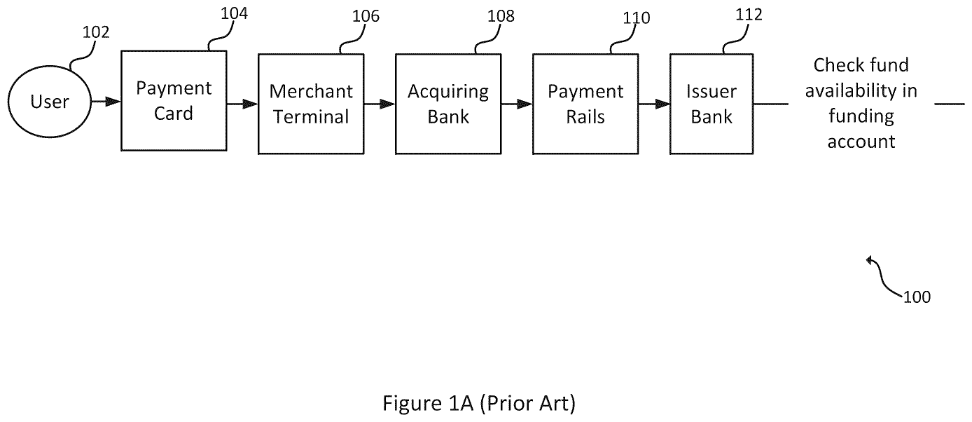

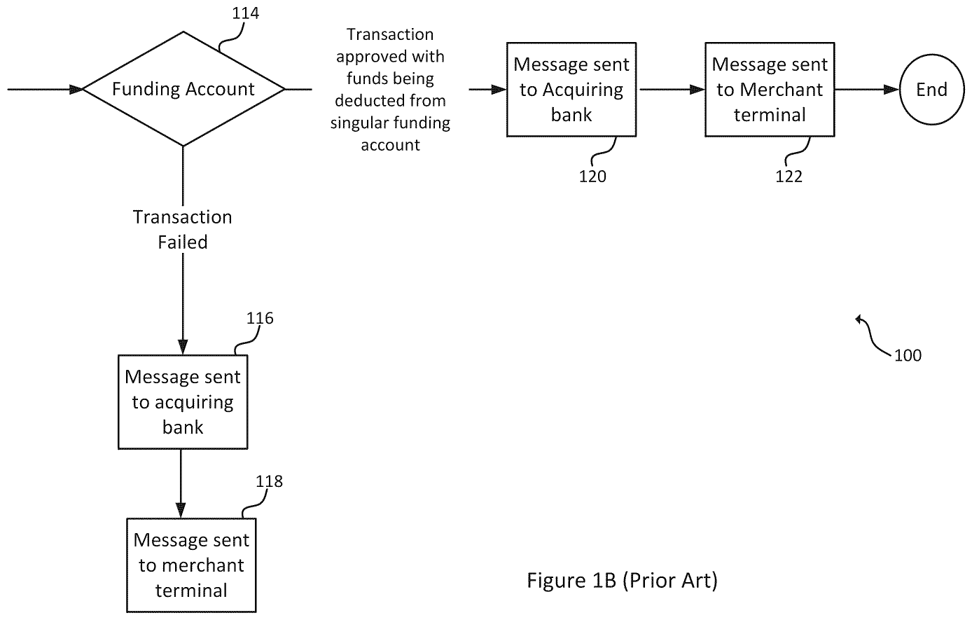

FIG. 1A, 1B is a prior art method 100 of managing transactions. A user 102 may present a payment card 104 at a merchant terminal 106. An amount associated with the transaction (transaction value, which may include applicable tax(es)), and one or more details associated with the payment card 104 (e.g., issuer bank with which the payment card 104 and user 102 are associated, payment card number etc.) may be determined by the merchant terminal 106 and sent to an acquiring bank 108 with which the merchant terminal is associated. The acquiring bank 108 may communicate with the issuer bank 112 using payment rail(s) 110 set up between the acquiring bank 108 and the issuer bank 112. The issuer bank 112 may determine (at step 114) if the funding account associated with the payment card has sufficient funds to honour the transaction. If there is insufficient funds in the funding account (i.e., the funding account associated with the payment card 104 has funds less than the amount associated with the transaction), transaction fails and a notification (e.g., a message) confirming that the transaction has been declined may be sent by the issuer bank 112 to the acquiring bank 108 (step 116) and subsequently to the merchant terminal 106 (step 118). If there are sufficient funds in the funding account (i.e., the funding account associated with the payment card 104 has funds more than the amount associated with the transaction), the transaction gets approved and funds worth the same amount as the amount associated with the transaction are deducted from the funding account. A notification (e.g., a message) confirming that the transaction has been approved may be sent by the issuer bank 112 to the acquiring bank 108 (step 120) and subsequently to the merchant terminal 106 (step 122) and the method 100 ends.

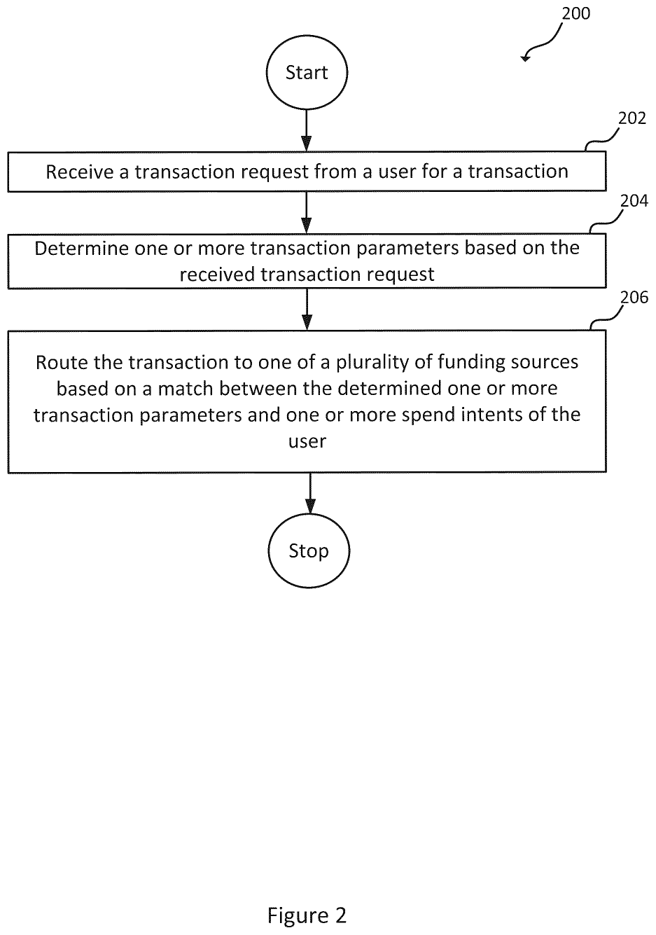

FIG. 2 is a flow diagram of a method 200 of managing a transaction according to an embodiment of the present disclosure. The method 200 comprises receiving a transaction request from a user for a transaction (step 202), determining one or more transaction parameters based on the received transaction request (step 204), and routing the transaction to one of a plurality of funding sources based on a match between the determined one or more transaction parameters and one or more spend intents of the user (step 206). Throughout this disclosure, a user may refer to the spender who submits one or more spend intent(s) and transaction request(s), and a funder may be an approver/employer/company/organization/bank/lender.

A spend intent may be a request or suggestion for a transaction in anticipation of the transaction that may occur at a future time. Each of the one or more spend intents may be a request or suggestion for a transaction submitted by the user prior to submitting a transaction request. In an example, the spend intent may be an intention of the user to spend a certain amount of money in a future transaction for a certain purpose such as, but not limited to, taking a client of the user out for a beverage, meal and/or entertainment, travel-related expense for a business trip by the user (e.g., flight ticket(s), hotel accommodation, taxi fares, conference registration cost etc.). Accordingly, the spend intent may be a request, a suggestion or an anticipated transaction input by the user for a future transaction. The spend intent may be input by the user into a user interface of a computing device such as a phone, a laptop, a tablet, a computer or any suitable computing device.

In an embodiment, upon receiving a spend intent from the user, one or more spend intent parameters may be determined. Spend intent parameters may include one or more of: one or more funder policies relevant to the user (spender) (e.g., based on the user's role and/or level within the organization if the organization is the funder), type of transaction intended, range of transaction amount for the type of transaction intended, location where the intended transaction is to occur, cost per person for an intended product or service for which the transaction is desired to be made, behavioral pattern(s) of other users within the organization who are of a similar role and/or level as the user. The funder policy may determine if the spend intent is aligned with a business goal of the funder. In an exemplary embodiment where the spend intent is to take an existing or potential client for dinner, the user may receive a request to input additional information such as, but not limited to, client name, location of restaurant, intended transaction amount, date and/or time for the transaction in the future. In an embodiment, if the spend intent parameter does not comply with the one or more funder policies (e.g., the spend intent is determined to breach one or more funder policies), an exception may be generated which may trigger an approval request to an authorized personnel of the funder. The range of transaction amount for the type of intended transaction may be determined based on historical records of the funder. In various embodiments, the range may include one or more applicable taxes.

In one or more embodiments, a policy refers to a governance framework representing the funder's or sponsor's intent regarding an authorised use of funds. A policy may define the purpose, scope, conditions and/or boundaries within which money may be spent and may serve as the decision framework through which the proposed methods and systems on/across which the methods are implemented may determine whether a spender's intent (a request to spend) aligns with the funder's intent prior to authorisation. A policy may exist in either a structured form (e.g., predefined rules, budgets, merchant-category restrictions and/or compliance datasets) or in unstructured form (e.g., free-text guidelines, correspondence, contextual data and/or inferred behavioural patterns that reflect the funder's objectives, priorities, or ethical standards). Artificial intelligence within the system may interpret, derive, or transform unstructured funder context into structured policy representations to enable automated evaluation and reasoning. Policies may comprise, without limitation: purpose-based constraints defining permissible or prohibited categories of expenditure (for example, disallowing purchases of alcohol, entertainment, or personal items); merchant-category rules or restrictions, specifying allowable or disallowed merchant types or categories, identified through Merchant Category Codes (MCCs) or equivalent classification schemes; financial and operational controls, such as spending limits, departmental budgets, project allocations, temporal or geographic limits, and approval hierarchies; and/or governance and ethical conditions, reflecting the funder's strategic, contractual, regulatory, or moral intent, including grant-use obligations, ESG principles, or partner-program compliance. A policy may be static i.e., defined by fixed organisational and/or funding parameters, or dynamic i.e., evolving through artificial-intelligence-driven reasoning based on behavioural, contextual, or environmental inputs.

During operation, the spender's intent is captured or inferred and evaluated against one or more policies that embody the funder's intent. When the one or more proposed methods determine that the spender's intent satisfies the conditions of the applicable policy framework, the method authorises the intent and generates a pre-transaction authorised token i.e., a spend token. This spend token represents the verified alignment between the funder's intent (as expressed through the policy) and the spender's intent, and serves as an output for controlling real-time payment authorisation and routing within existing payment rails.

The determined one or more spend intent parameters may then be assessed against an approval condition. The approval condition may be defined based on one or more funder policies relevant to one or more business goals of the funder (e.g., business development, team building, revenue increase, resource management etc.). In an embodiment, the assessment of whether the determined one or more spend intent parameters satisfies the approval condition may be done automatically. In another embodiment, the assessment of whether the determined one or more spend intent parameters satisfies the approval condition may be done manually by an authorized approver.

In response to the determined one or more spend intent parameters satisfying the approval condition, an account parameter set may be generated. The account parameter set may comprise one or more of the following parameters: an intended transaction value, an intended transaction time, an intended transaction date, applicable tax(es), payment network charge, currency, merchant name, merchant ID, merchant category code(s), terminal type, terminal ID. In an embodiment, values for one or more of the parameters in the account parameter set may be set based on values of corresponding spend intent parameters determined from the user's spend intent input. In another embodiment, values for one or more of the parameters in the account parameter set may be set based on values of corresponding spend intent parameters determined from historical user spend intent inputs or historical spend intent inputs from other employees of similar role or level as the user.

A plurality of funding sources may be made available to honour a transaction made by the user. Each of the funding sources may be associated with one or more account parameter sets generated as described above. Stated differently, for each generated account parameter set, a funding source may be created.

When a user submits a transaction request, one or more transaction parameters associated with the transaction may be determined. In an embodiment, the one or more transaction parameters may comprise any one of: a transaction value, applicable taxes, bank charges, payment network charges, merchant identity (e.g., merchant name, merchant identity number (ID)), merchant category code, location code, currency in which the payment was made, transaction value in native currency, time, date, terminal ID, terminal type (Online or Physical point of sale (POS) terminal), Invoice ID, Purchase Order ID, Product code, Product specification. A match between the one or more transaction parameters and corresponding parameters of the generated account parameter set (generated based on the spend intent submitted by the user prior to the transaction as discussed above) may be performed. Based on the level of match, the transaction may be routed to one of the plurality of funding sources to which the account parameter set is associated or to another one of the plurality of funding sources designated as the fallback funding source. In an embodiment, the transaction may be routed to another one of the plurality of funding sources designated as the fallback funding source if the transaction value is below a preset value set of the fallback funding source. In an exemplary embodiment, a funding source may be associated with a set purpose/business goal such as a budget e.g., a local travel budget and all local travel, irrespective of date, time (or any other parameters) would be sent to the funding source as long as the transaction value is lower than the set budget. Accordingly, each of the transaction requests with the varying parameters such as date, time etc. associated with the local travel (i.e., related transactions) may be routed to the specific funding source. Embodiments of the present disclosure may allow routing of a transaction to one of a plurality of funding sources for managing the transaction based on one or more policies of a funder and spend intent of the spender.

An exemplary embodiment is described as follows. An account executive at a technology company may require a real-time understanding of whether their intention to make a spending in the future in association with a funder-related task may get approved or not prior to making the spending/transaction. When attending an industry conference, the executive may plan to take a potential client to dinner aiming to close a major deal. In an embodiment, the user may get prior approval from an authorized personnel such as their manager for $200 per person if they know that dinner at the desired restaurant may exceed a standard $100 per person limit. Accordingly, the executive may submit the following as their spend intent: “Have dinner with client at a steakhouse for $200 per person” in advance of making the transaction to understand whether or not the intent will be approved and prior to proceeding to make the transaction. In an embodiment, the user may be requested to provide additional information such as, but not limited to, the name of the client, the name of the steakhouse, and expected date and/or time of the dinner.

Upon receiving the spend intent from the user, one or more spend intent parameters may be determined by a domain-specific AI Agent (described in further detail below) as follows: (a) it may be determined if the intended transaction value ($200 in this example) is within funder policy relevant for the user. If it is determined that the intended transaction value does not comply with the funder policy relevant for the user, an exception may be generated which may trigger an approval request to an authorized personnel of the funder who is authorized to review and/or approve such exception(s); (b) a range for this type of transaction (i.e., dinner with a client), based on the historical records of the company, which may include applicable taxes, (c) a location for the steakhouse may be determined, (d) cost per user based on publicly available information on the steakhouse (e.g., web reviews, steakhouse website etc.) may be determined. If the user has not input the name of the specific steakhouse, a list of probable steakhouses based on past user behaviour may be determined by the domain-specific AI Agent and cost per person at those probable steakhouses may be determined by the domain specific AI Agent as mentioned above; (e) additional information relevant to the spend intent may be determined based on data retrieved from a customer relationship management application used by the funder such as, but not limited to, who the client is, how important the client is to the funder, what sales are being made to the client, client complaints, etc.; (f) behavioral pattern(s) (e.g., spend patterns and/or spend intent pattern(s) for other users in the organization who have a similar role and/or level as the user may be determined. The domain-specific AI Agent may assess the cost associated with the user's spend intent, and potential location(s) and send these two spend intent parameters (i.e., transaction value, location) on to a Virtual Funding Account Manager, where these parameters may be matched/evaluated against one or more transaction parameters associated with an incoming transaction as will be described in more detail below.

The spend intent and the determined one or more spend intent parameters may then be assessed against an approval condition. The assessment of whether the determined one or more spend intent parameters satisfies the approval condition may be done automatically. In another embodiment, the assessment of whether the determined one or more spend intent parameters satisfies the approval condition may be done manually by an authorized approver. In an embodiment, the approver may request additional information prior to manually determining whether the determined one or more spend intent parameters satisfies the approval condition, and the domain-specific AI Agent may obtain the requested additional information or predict one or more parameters associated with the requested additional information as described above to then pass on the parameters to a virtual funding account manager for subsequent matching/evaluation as discussed above and described in further detail elsewhere in the disclosure. Once the determined one or more spend parameters is determined as satisfying an approval condition, a notification (e.g., message) may be relayed back to the user and an account parameter set may be generated corresponding to the spend intent and/or the determined spent intent parameters. Spend intents, their corresponding one or more determined spend intent parameters, approval/decline records may be stored in a database as historical records for future spend intent and/or transaction management as described elsewhere in this disclosure. If the determined one or more spend parameters is determined as not satisfying an approval condition, a notification (e.g., message) may be relayed back to the user which may optionally include a reason for declining the spend intent submission. In an embodiment, the reason may be selected from a predetermined list of reasons. In another embodiment, the reason may be provided by the approver.

### Exemplary Account Parameter Set

| Parameter of the Account | |
|---|---|
| Parameter Set | Value |
| Intended Transaction Value | Minimum: $200; Most Likely: $400; |
| | Maximum: $550 |
| Intended Transaction Time | 6:00 pm to 7:00 pm |
| Intended Transaction Date | Between 1 Nov. 2024 and 10 Nov. 2024 |
| Applicable Tax | 10% of intended transaction value |
| Payment Network Charge | 0.1% of intended transaction value |
| Currency | Australian Dollars |
| Merchant Name | ABC Steakhouse |
| Merchant ID | (as provided by the payment network) |
| Merchant Category Code | 5812, 5813 |
| Terminal Type | Physical Point of Sale |
| Terminal ID | (as provided by the payment network) |

A funding source may be an abstraction or an abstract representation of a bank account (checking account, savings account etc.) that may be a ledger within a bank to keep record of transactions and to show how much the bank owes a customer or is owed from the customer at any given point in time. The funding source or virtual funding account (“VFA”) may allow a bank account to be sub-divided into smaller parts that can be dedicated for specific use cases. Such an abstraction may allow for virtual limits for transactions without having to expose the total balance in the bank account. When a user submits a spend intent, the spend intent may be converted into a funding source or virtual funding account. As described above, one or more spend intent parameters may be determined based on the spend intent, and upon the one or more spend intent parameters satisfying an approval condition, an account parameter set may be generated. Each account parameter set may be considered as an individual funding source or virtual funding account (VFA). In an embodiment, a plurality of account parameter sets may be considered as a single funding source/account. The funding source/account would contain a collection of parameters (i.e., account parameter set) that would be compared in real-time against one or more transaction parameters associated with a transaction to see if there is a match at the payment instance i.e., when the transaction request is received.

Exemplary Matching Between One or More Transaction Parameters Associated with a Transaction and an Account Parameter Set

| | Funding Source or Virtual | Transaction | |
|---|---|---|---|
| Parameters | Funding Account (VFA) | Parameter | Match |
| Transaction Value | Minimum: $200; Most Likely: $400; | $210 | Yes |
| | Maximum: $550 | | |
| Transaction Time | Between 6:00 pm and 7:00 pm | 8:30 pm | No |
| Transaction Date | Between 1 Nov. 2024 and 10 Nov. 2024 | 2nd Nov. | Yes |
| | | 2024 | |
| Applicable Tax | 10% of transaction value | $21 | Yes |
| Payment Network | 0.1% of transaction value | $0.21 | Yes |
| Charge | | | |
| Currency | AUD | AUD | Yes |
| Merchant ID | 10000111, 10000121, 10000453 | 1000489 | No |
| Merchant Category | 5812, 5813 | 5812 | Yes |
| Code | | | |
| Terminal Type | Physical Point of Sale | Physical Point | Yes |
| | | of Sale | |
| Terminal ID | 10111, 10153, 10189, 10873 | 10489 | No |

The payment card (physical card or digital card) allocated to the user may be associated with each of a plurality of funding sources e.g., a first funding source (alternatively referred to as a virtual funding account “VFA” 1), a second funding source (alternatively referred to as a virtual funding account “VFA” 2). The first funding source may be associated with an account parameter set as shown above. The second funding source may be designated as a fallback funding source or a general funding source with another associated account parameter set. In an example, the account parameter set associated with fallback funding source, or a general funding source may comprise: any transaction type with an intended transaction value up to $1000, in any currency and any intended transaction date and/or intended transaction time.

When the executive presents their payment card at a terminal (physical or online) to make a transaction request e.g., pay for the dinner with the client at a restaurant, the card may identify the transaction as having the following transaction parameters: transaction value of $350, transaction date of 1 Nov. 2024, Merchant category code 5812, a merchant ID and a location where the transaction request has been placed. A match between the determined transaction parameters and the generated account parameter set may be performed and it may be determined that while the transaction value of $350, transaction date of 1 Nov. 2024 and Merchant category code of 5812 match corresponding parameters in the generated account parameter set that was generated based on the executive's spend intent submission earlier, the merchant ID and location do not match. This may happen for reasons such as the executive deciding on a different restaurant on the day for certain reasons (e.g., client's preference). Based on the match determination, the transaction may be routed to the fallback funding source VFA 2. Accordingly, the transaction may be approved and the amount of $350 may then be deducted from the fallback funding source.

The match may be based on a weightage assigned to one or both of the user, funder (e.g., employer employing the user). A determination as to which VFA may be the most appropriate may be based on the account parameter set associated with each VFA (as discussed in the example above). In various embodiments, a priority order in which the account parameter sets and/or the individual parameters in each of the account parameter sets may be evaluated for the transaction routing, the weightage that may be assigned to each of the parameters in each of the account parameter sets and/or to the account parameter set may be algorithmically determined. The priority order of VFAs and/or weightage may be dynamically updated and may be different per user and/or per funder. Accordingly, the plurality of funding sources or VFAs may differ based on the account parameter sets and/or the individual parameters in each of the account parameter sets to which the funding source is associated. A number of funding sources or VFAs connectable to a card may be based on a number of user spend intents. VFAs may be dynamically created, modified, deleted based on user spend intents e.g., for every user spend intent, a distinct VFA may be created and may subsequently modified/deleted based on user input.

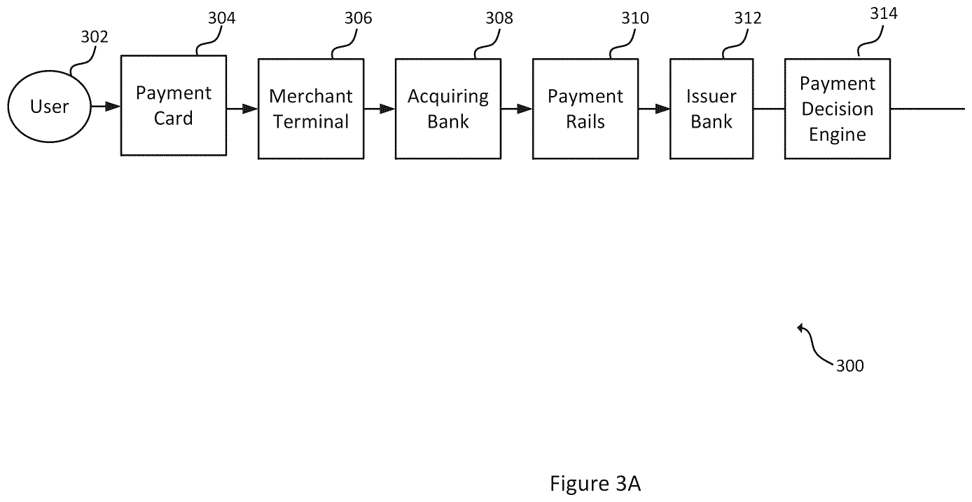

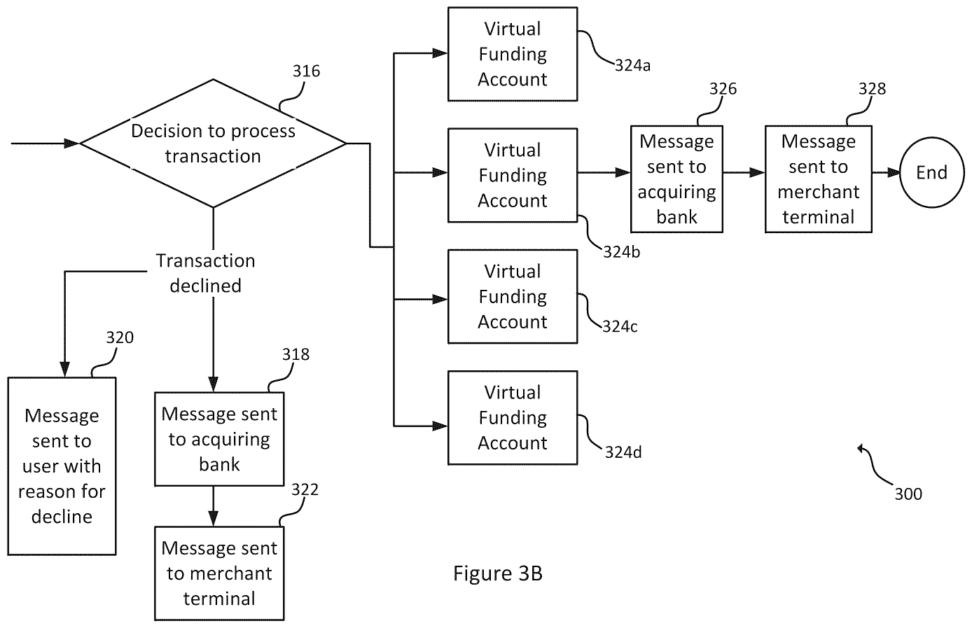

FIG. 3A, 3B is a method 300 of managing a transaction according to an embodiment of the disclosure. A user 302 may present a payment card 304 at a merchant terminal 306. An amount associated with the transaction (transaction value) and one or more details associated with the payment card 304 (e.g., issuer bank with which the user 302 and the payment card 304 are associated, payment card number etc.) may be determined by the merchant terminal 306 and sent to an acquiring bank 308 with which the merchant terminal is associated. The acquiring bank 308 may communicate with the issuer bank 312 using payment rail(s) 310 set up between the acquiring bank 308 and the issuer bank 312. The issuer bank 312 may communicate with a payment decision engine 314 to perform at least one of the following determining steps (step 316): (a) determine which of a plurality of virtual funding accounts 324 (324a, 324b, 324c, 324d . . . ) associated with the payment card 304 is most appropriate for the transaction as discussed elsewhere in the disclosure, and (b) determine (at step 316) if the most appropriate virtual funding account 324 (324a, 324b, 324c, 324d . . . ) associated with the payment card determined as described above has sufficient funds to honour the transaction. If there is insufficient funds in the most appropriate virtual funding account (i.e., the most appropriate funding account associated with the payment card 304 has funds less than the amount associated with the transaction), transaction fails and a notification (e.g., a message) confirming that the transaction has been declined may be sent by the issuer bank 312 to the acquiring bank 308 (step 318) and subsequently to the merchant terminal 306 (step 322). In an embodiment, a notification may be sent to the user 302 (e.g., message to the user's mobile phone, computer, laptop, tablet etc.) indicating a reason for decline. If it is determined that there is sufficient funds in the most appropriate virtual funding account (i.e., the most appropriate funding account associated with the payment card 304 has funds more than the amount associated with the transaction), the transaction gets approved and funds worth the same amount as the amount associated with the transaction are deducted from the relevant/most appropriate virtual funding account. A notification (e.g., a message) confirming that the transaction has been approved may be sent by the issuer bank 312 to the acquiring bank 308 (step 326) and subsequently to the merchant terminal 306 (step 328) and the method 300 ends. The plurality of virtual funding accounts 324 may be separate funding accounts associated with the single payment card 304 at the issuer bank 312 or separate sub-accounts created from a single funding account associated with the single payment card 304 at the issuer bank 312.

Payment rails may be a network through which banks pass messages to each other to clear or process transactions. These networks may have standardized messaging formats, and may be able to route transactions in under a few seconds. By implementing the present disclosure on a payment rail, a single payment card may be connectable to more than a single bank account from the same or different banks. In an embodiment, the payment rail may allow decoding of the spend intent parameters into the user spend intent such that the transaction can be routed between multiple banks. FIGS. 3A, 3B therefore describe the payment rails and modification of the behaviour of the payment card using the payment decision engine and VFAs.

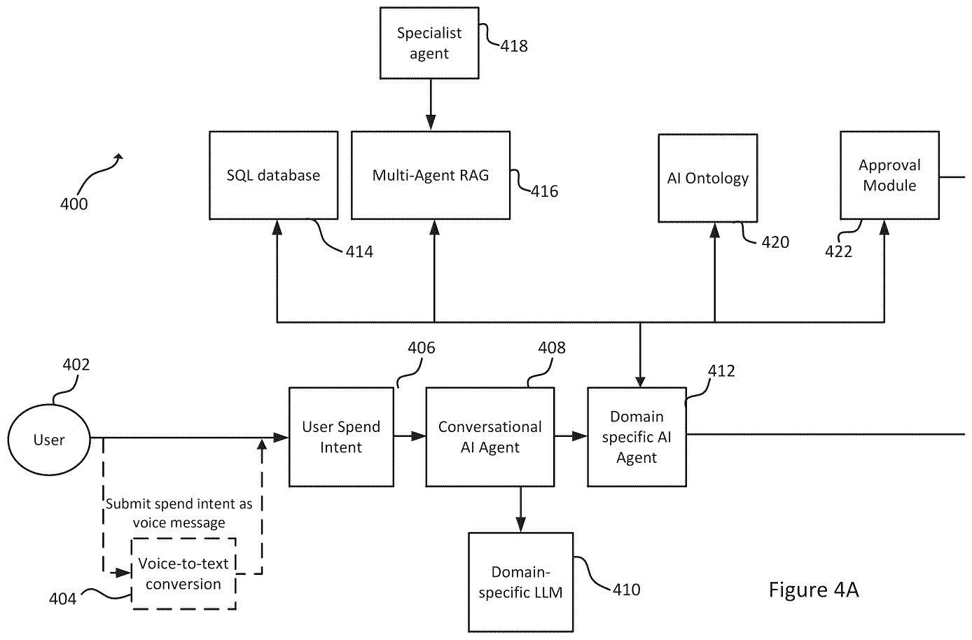

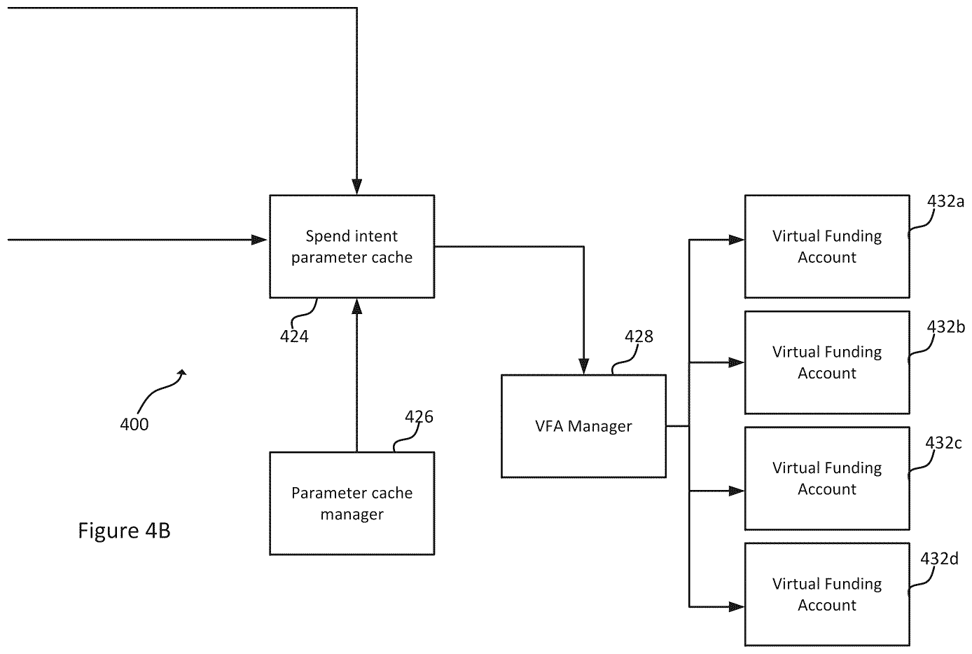

FIG. 4A, 4B is a detailed method 400 of managing a transaction by modifying the behaviour of the payment rail 310 of FIG. 3A, 3B, and thereby modifying the behaviour of the payment card 304, according to an embodiment of the disclosure. A user 402 may submit a spend intent. In various embodiments, the spend intent may be received as a structured data or an unstructured data (e.g. a text or a voice message, a global URI/URL such as current WWW or semantic web, from a data source directly through a third-party computer program or from a user device (mobile phone/computer etc.). The spend intent may be submitted prior to the transaction request. In an embodiment, the spend intent request and the transaction request may be submitted by the user at different points in time e.g., the spend intent may be submitted to a computing device that is not a merchant terminal few minutes, hours, days, weeks or months in advance of submitting a transaction request at the merchant terminal.

Unstructured data may be data that is not formatted according to the requirements of the one or more processing modules shown in FIGS. 4A, 4B, but may remain native to the application in which it was originally created (e.g., in a calendar appointment, the data may be structured native to the calendar app, and may be submitted directly in the format in which it was created in the calendar app). Accordingly, the present disclosure may be indifferent to receiving data in structured or unstructured format. If the spend intent is received as unstructured data, it may be converted into structured data corresponding to the one or more transaction parameters associated with a transaction.

In an embodiment, the user may submit the spend intent within an application or a web browser running on a computing device such as a mobile phone, a table, a laptop, a desktop computer etc. The approval may happen within the application or the web browser. If the approval may require a manager/another person in the company who is the authorized approver, the application or the web browser may send a notification to the authorised approver, who can then approve the request within the application or the web browser.

If the spent intent is received as a voice message, voice to text conversion may be performed (404) to infer user spend intent 406 as described above. A conversational AI Agent 412 may receive and process/infer the user spend intent. In an embodiment, the conversational AI agent 408 may be based on a domain-specific large language model (LLM). A domain-specific LLM may be an LLM that has been trained to understand the above-described payment domain including, but not limited to, card payments, finance, accounting. The LLM may be able to determine or infer one or more of: the specific user, card owner, card issuer (which may collectively be referred to as a ‘domain’). The user spend intent inference may be done using large language model (LLM) having the capability of understanding user input and inferring meaning from it with reasonable accuracy for the purpose of this disclosure.

In an embodiment, the conversational AI agent 408 may refer to an instance of an LLM that the user may converse with. The conversational AI agent 408 may be equipped with the ability to hold a natural conversation with a human user (e.g., via text, voice, images, video, data from a third-party program or various combinations of these), to understand what the user is intending with reference to their spend intent. Once the conversational AI Agent 408 understands what the user wants, it may hand off specific tasks (i.e., understanding historical spend patterns, historical spend intents, their corresponding one or more determined spend intent parameters, approval/decline records, understanding company policy etc.) to AI Agents which may be LLMs that have been fine-tuned for specific tasks/groups of tasks. Such fine-tuning for specific tasks may be referred to as ‘domain specific AI Agents’ 412. These domain-specific AI agents 412 may have the capability to access third party programs (software code) and provide information to the conversational AI agent to provide feedback to the user, regarding the collective decision of the domain specific AI Agent 412.

The output of the conversational AI agent 408 is input to the domain-specific AI agent 412 which may parse the user spend intent into multiple specific tasks/programs as follows. An SQL database 414 may comprise historical data and/or structured data as described elsewhere in this disclosure. Multi-Agent Retrieval Augmented Generation (RAG) 416 may break down user input into components that may be sent to ‘multiple agents’ to retrieve information from specific data and then provide an augmented answer back to the main agent. Such a method may be used to add specific knowledge to the AI agent that may not be present with the AI agent's original training. A Specialist Agent 418 may perform one or more of the following tasks such as, but not limited to: browsing the web for public information that would be needed to fulfill user spend intent request, connecting to third party applications via APIs to obtain information/perform actions, based on the user's input (e.g., connecting to an accounting system to understand historical transactions), performing specialized financial management related tasks such as budgeting etc.

AI (Artificial Intelligence) Ontology 420 may provide information including who the user is, what they are allowed to do, what information they may be able to access, third party applications the user may access using AI, relationship of the user with other users in the system or method disclosed above, as well as capabilities in order to perform the correct action. Ontology may refer to a formal representation of knowledge within a specific domain. Ontology 420 may define the concepts, categories and/or relationships between them in a structured manner that may enable systems to understand and reason about the data in a more human-like way. Ontology in AI may include (a) Attributes (properties or characteristics of the concepts, like transaction value, date, or currency), (b) Concepts (basic entities or things in the domain, such as objects, events, or processes), (c) Relationships (how concepts are related to each other, such as hierarchical relationships (e.g., “is a type of”) or associative relationships (e.g., “is part of”)), (d) Rules (constraints or logical statements that define how concepts and relationships can interact). Accordingly, the AI Ontology 420 may provide context about the user's spend intent that otherwise may not be available. The context may not be a static set of data blocks, but more a method of describing relationships between various data objects (which may represent people, physical objects or digital abstractions), which may continuously change.

By using Ontology 420, the LLM agents such as the specialist agent 418 may be able to better understand the context of the spend including, but not limited to, who the approver is, whether the spend intent and/or the transaction would need approval from the approver or if the transaction and/or spend intent can be automatically approved, in order to give an appropriate result i.e., approval or refusal/declining of the spend intent request. Further, in an example, if the spend intent input by the user is “I'd like to get an approval for my trip to Sydney for a conference”, the Ontology 420 may assist the LLM agents to better understand if the trip to Sydney would coincide with the funder policy and/or cost for attending such a conference, which may not be possible without the use of Ontology. FIGS. 4A, 4B therefore describe the programming/application that may use large language models/AI that may enable the creation of VFAs and the payment decision engine.

The approval module 422 may approve or decline a user spend intent based on one or both of pre-defined rules and/or by a human in the loop as described elsewhere in this disclosure. The approval module 422 may authorize a new user or approve a particular transaction.

The domain-specific AI agent 412 may determine or generate, populate spend intent parameters. A spend intent parameter cache 424 may receive the generated and populated spend intent parameters from the domain-specific AI agent 412 and output from the approval module 422. The spend intent parameter cache 424 may comprise an inference engine (alternatively referred to as a funding cache). The spend intent parameter cache 424 may work as an inference engine to store and/or manage some or all data and/or data objects that may be frequently accessed while the domain-specific AI agent 412 performs its task. Doing so may allow the domain-specific AI agent 412 to access information faster instead of sifting through large database(s) each time if data is stored in persistent memory/storage, which may take longer. In an embodiment, the spend intent parameter cache 424 may communicate with a parameter cache manager 426 that may perform one or more of the following tasks: clean, recycle, manage spend intent parameter cache 424. In an embodiment, the spend intent parameter cache 424 may proactively retrieve, pre-authorise and/or populate predicted transactions and/or payment policies. In an embodiment, the spend intent parameter cache 424 may load the generated account parameter set(s) to the corresponding VFAs 432a, 432b, 432c, 432d, or create a VFA for one or more of the generated account parameter set(s). As described above, the domain-specific AI Agent 412 may assess cost associated with a user's spend intent, and potential location(s) for performing the transaction in a future time, and send these two spend intent parameters (i.e., transaction value, location) on to the Virtual Funding Account Manager 428, where these parameters may be matched/evaluated against one or more transaction parameters associated with an incoming transaction in real-time when the transaction request is received.

The VFA manager 428 may handle one or more of dynamic creation, update/modification, deletion of VFAs based on user spend intent input as discussed above. The VFA Manager 428 may be an intermediary tool that may help manage the plurality of VFAs (i.e., to create, edit, update, delete one or more of the plurality of VFAs). The inference engine in the spent intent parameter cache 424 may parse the correct/appropriate parameters to the corresponding VFA via the VFA Manager 428. In an embodiment, such parsing may be done by the inference engine directly. In another embodiment, such parsing may be decoupled to allow for better performance by allowing each of the separate components (SQL database 414, Multi-Agent RAG 416, Specialist agent 418, AI Ontology 420, Approval module 422) to be optimized for doing the relevant specialized task.

As described above, spent intent may be used to determine spend intent parameters, generate account parameter set(s), and associated business domain-specific contextual information and may be a pre-transaction process i.e., that occurs before the actual transaction takes place. The method 400 described in FIGS. 4A, 4B may take place in real-time when a user submits their spend intent and may provide real-time indication of whether or not their spend intent is approved which may indicate higher likelihood of a transaction that matches the spend intent also getting approved in a future point in time.

The method 300 described with respect to FIGS. 3A, 3B describe the payment Context which may take into account the conditions that influence to augment a real-time classification or matching between a transaction and previously submitted spend intents. Payment context may start to get accumulated from the build phase where initial spend intent recognition may happen and may get updated as time passes by, all the way to the real-time context update (e.g., time, user location, store/payment location etc.) at the time of the transaction.

In another exemplary embodiment of the present disclosure, the proposed method may be applied to the field of fleet management, such as for managing and authorizing fuel card transactions by enabling proactive authorization of fuel spend through multi-modal intent capture to enable real-time contextual spend control. In this embodiment, once a driver completes refueling, the driver captures one or more images of the fuel pump display showing data such as, but not limited to, the number of litres dispensed and the total amount payable. The image(s) constitute a multi-modal representation of spend intent and may be processed in real-time by a domain-specific AI agent/engine integrated within the disclosed pre-transactional intelligence framework.

The domain-specific AI agent/engine extracts one or more structured parameters from the captured image(s), such as, but not limited to, (a) total transaction amount, (b) volume dispensed, (c) price per litre, (d) fuel station identification derived from geolocation and merchant data, and (e) timestamp. The intended transaction value is automatically captured from the image(s) of the pump display. In cases where the displayed amount is unclear or unreadable due to factors such as glare, low lighting, and/or image distortion, the proposed method may prompt the driver to manually input the intended transaction value. The extracted and/or input parameters are then used to generate a spend intent record and a corresponding account parameter set. The account parameter set may define one or more constraints such as merchant ID, location coordinates, permissible variance thresholds, and a transaction validity window.

Upon validation of the extracted and/or input parameters against applicable funder policies (e.g., fuel type, maximum refill amount, and/or refueling frequency), the method may automatically generate a spend token representing a pre-authorized payment equal to the transaction value displayed on the pump or manually input by the spender (e.g., driver). This spend token is mapped to a Virtual Funding Account (VFA) linked to the driver's payment card. In an example, the spend token may be time-bound i.e., the token may become active within a predetermined time following photo capture and/or stay active for a predetermined time.

When the driver proceeds to the payment counter and presents the fuel card, the transaction request initiated at the point of sale is evaluated against the live/active spend token. Only if the transaction parameters (e.g., value, location, merchant ID, and time) match the pre-authorized spend token will the transaction be approved and routed to the corresponding VFA. If any mismatch occurs—for example, if the spender attempts to include unrelated purchases and/or exceed the authorized amount—the transaction is automatically declined or redirected for manual approval. In some embodiments, a match between one or more of the transaction parameters and the pre-authorised spend token above or equal to a predetermined similarity threshold may be sufficient to approve the transaction and route the transaction to the corresponding VFA. Such fuzzy matching may be enabled by using suitable artificial intelligence models.

In this embodiment, the proposed method may effectively transform the image of the pump display into a structured, verifiable spend authorization, ensuring that fuel card transactions comply with organizational policies at the moment of spend rather than being verified retrospectively and generate a spend token in real-time following capture of the image(s). In one embodiment, the transformation of the image(s) into the structured, verifiable spend authorisation may be performed by artificial intelligence (AI) (e.g., multimodal AI). The method may further address the limitations of single or limited type use codes by ensuring the transaction parameter(s) are associated with the specific good(s) or service(s) (e.g., fuel) and not associated with other good(s) and/or service(s) (e.g., food sold in the fuel pump store) and matching those parameter(s) with the spend token generated in real-time.

In certain embodiments, the method may also perform post-spend verification randomly or at predetermined intervals to maintain continuous compliance integrity. In such instances, the driver may be prompted to capture one or more further image(s) of the pump display and/or the printed receipt after payment is completed. The method may compare the post-spend image(s) against the original spend intent record and transaction data to verify consistency between the authorized amount and the actual amount paid. Any detected variance may be flagged for review by the funder and/or a system administrator, to provide an additional layer of policy enforcement and/or fraud prevention. In one example, such comparison may be performed using suitable artificial intelligence models.

### Exemplary Account Parameter Set

| Parameter of the Account | |
|---|---|
| Parameter Set | Value |
| Intended Transaction Value | Captured automatically from pump photo; |
| | manually entered if image unclear |
| Intended Transaction Time | 9:00 am-9:15 am |
| Intended Transaction Date | 20 Nov. 2024 |
| Applicable Tax | 10% of intended transaction value |
| Merchant Name | Shell Fuel Station - Dandenong |
| Merchant ID | (as provided by the payment network) |
| Merchant Category Code | 5541 |
| Location Code | Within 2 km of Dandenong, VIC |
| Terminal Type | Physical Point of Sale |
| Terminal ID | (as provided by the payment network) |
| Multi-Modal Input | Image Capture (Fuel Pump Display) |
| Token Validity | 10 minutes post image capture |
| Post-Spend Verification | Random image audit to validate |
| | authorized vs actual spend |

The method described above may be implemented based on the framework and associated method illustrated in FIGS. 4A and 4B of the present disclosure. In this embodiment, the image(s) of the fuel pump captured by the spender is received by the conversational AI agent and processed by a multi-modal domain-specific AI agent capable of interpreting image data alongside textual and/or contextual inputs. The multi-modal agent may perform optical character recognition (OCR) on the captured image(s) to extract numerical and/or textual information, such as total transaction amount, litres dispensed, and price per litre. Concurrently, metadata such as, but not limited to, geolocation, timestamp, and device identification may be extracted and cross-verified against known merchant data and/or fuel station coordinates stored within the ontology database.

The domain-specific AI agent may then generate one or more spend intent parameters from the extracted data and transmit those parameters to the spend intent parameter cache. The cache, functioning as an inference engine, stores the structured data and communicates with the Virtual Funding Account (VFA) Manager to generate an account parameter set and a corresponding spend token. The VFA Manager may dynamically create or update a virtual funding account linked to the driver's payment card, assigning the parameters derived from the image input—such as merchant ID, location, value range, and time validity window—to that account. The payment decision engine may subsequently reference the token at transaction time, ensuring that the incoming transaction parameters received through the payment rail match those of the authorized spend token before routing the transaction for approval.

In an embodiment, the disclosure may also comprise a post-spend verification module. The post-verification module may trigger compliance checks after transaction completion randomly or at predetermined intervals, requesting the driver to capture one or more additional image(s) of the pump display and/or payment receipt. The proposed method may compare the post-spend image(s) against the previously stored spend intent record to verify accuracy of transaction value, merchant ID, and/or timestamp. Any detected deviation between the authorized spend token and the verified transaction data may initiate an automated exception workflow for funder review, thereby closing the feedback loop between pre-spend authorization and post-spend validation.

Such additional multimodal integration may extend the disclosed method beyond text-based intent capture to incorporate multi-modal pre-transactional intelligence, enabling real-time, image-driven spend authorization that can operate natively within existing payment networks and/or virtual funding account infrastructure.

This embodiment may allow enforcement of real-time compliance and elimination of unauthorized transactions in fleet management environments. By enabling spend authorization through image-based pre-transactional intelligence, the method may ensure that each refueling event is contextually validated before the payment occurs. The captured image(s) of the fuel pump display may function as a multi-modal verification artifact, allowing the methods disclosed herein to convert a visual record of the transaction into structured data parameters—such as amount, fuel volume, merchant location, and time window—thereby achieving high-fidelity spend validation.

Unlike traditional fuel card systems that rely solely on merchant category codes, the proposed embodiment may verify the actual transaction context, preventing misuse such as the purchase of non-fuel items at fuel stations sharing the same MCC. The automated generation of a time-bound spend token from the captured image may ensure that payment authorization aligns with the spender's physical activity at the pump. Furthermore, the integration of random/predetermined interval-based post-spend verification provides a continuous feedback mechanism, allowing the proposed method to compare real-world spend evidence with the original pre-spend authorization, detect anomalies, and flag inconsistencies for review.

Accordingly, such embodiments may enhance policy enforcement, prevent leakage of corporate funds, reduce administrative overhead from manual reconciliation, and/or deliver auditable, AI-driven verification of fuel transaction within the proposed unified payment control framework.

In another embodiment of the disclosure, the methods described herein may be applied to the capture of pre-transactional intelligence derived from invoices and/or quotations prior to the execution of payment or purchase by introducing a multi-modal pre-transactional intelligence framework that permits users to capture and authorize a spend intent directly from one or more image(s) of an invoice or quotation prior to executing a payment transaction.

In operation, when a user receives an invoice (e.g., by email) from a vendor or service provider, the user may capture one or more image(s) of the invoice using a camera (e.g., standalone camera, camera integrated with a mobile device or any computing device). Similarly, at the point of purchase, when a user is presented with a printed quotation for goods or services (for example, when purchasing a laptop), the user may capture one or more image(s) of the quotation before making the purchase. The captured image(s) functions as a pre-transactional data source representing the spender's intent.

The captured image(s) may be processed by a multi-modal domain-specific AI agent configured to perform optical character recognition (OCR) and document intelligence to extract structured attributes, such as, but not limited to, vendor name, document type, invoice or quotation number, total amount, tax breakdown, currency, due date, line-item details, and purchase order reference. The extracted parameters are transmitted to the spend intent parameter cache and evaluated against one or more funder policies, budget thresholds, and/or approved vendor lists. If the spend exceeds policy and/or budget thresholds, the conversational AI agent may request clarification or justification from the user in real-time.

Upon validation, the proposed method may proceed to automatically generate an account parameter set and create a corresponding spend token representing the pre-authorized payment or purchase. The spend token may include one or more constraints such as the merchant identity, transaction amount, validity window, and project or cost center association. The spend token is then linked to a Virtual Funding Account (VFA) managed by the VFA Manager. When the user proceeds to execute the transaction, either via invoice payment or point-of-sale purchase, the payment decision engine validates the incoming transaction parameters against those defined in the spend token. Only if the parameters correspond to the authorized intent (e.g., by exact match, or a match above or equal to a predetermined threshold) is the transaction approved and routed to the designated funding source.

In one or more embodiments, a real-time expense report may be generated upon payment execution. The expense report is automatically populated with structured data from the invoice or quotation, ensuring that reporting and reconciliation occur contemporaneously with the transaction event. This continuous flow between spend intent, authorization, and reporting may provide improved governance and/or auditability compared to existing reactive systems.

In a further embodiment, the proposed method may operate in the absence of defined funder policies and/or budget rules. In such a configuration, the spend intent captured (e.g., from the invoice or quotation image(s)) may itself serve as the basis for generating a spend token without requiring policy validation. In an exemplary embodiment, the card may be associated with a user for personal expenses and not associated with an employer. Accordingly, the spender and the funder may be the same person and the spender may generate pre-transaction intelligence/spend intents and spend tokens and create VFAs from one or more of their funding sources to facilitate improved control over their expenditure from a funding source. In such embodiments, the policy may be set by the spender themselves and optionally have a set duration for which the policy is active. The domain-specific AI agent may infer transaction context directly from one or more of the extracted attributes—such as total amount, vendor, and due date—and convert them into an account parameter set. The resulting spend token may function as an autonomous pre-authorization, allowing the transaction to proceed while maintaining structured traceability and visibility. When policies and/or budgets are subsequently defined, they may be retroactively applied to historical transactions for compliance auditing and machine learning model refinement.

Accordingly, the disclosed method may ensure that pre-transactional intelligence is consistently captured, structured, and validated, even in policy-agnostic states, maintaining full system functionality and visibility across organizational spend.

### Exemplary Account Parameter Set

| Parameter of the Account | |
|---|---|
| Parameter Set | Value |
| Document Type | Quotation/Invoice (detected automatically) |
| Vendor Name | XYZ Computing Solutions |
| Document Reference | QTN-02345/INV-05890 |
| Intended Transaction Value | Captured automatically from image; manual |
| | confirmation if unclear |
| Currency | AUD |
| Tax Component | 10% GST |
| Validity/Payment Due Date | 15 Jan. 2025 |
| Purchase Order Reference | IT-CAPEX-0012 |
| Merchant Category Code | 5045 (Computers, Peripherals, and Software) |
| Location Code | Melbourne Office |
| Terminal Type | Physical Point of Sale/Online Transfer |
| Multi-Modal Input | Image Capture (Invoice/Quotation |
| | Document) |
| Token Validity | 7 days or until transaction completion |
| Post-Spend Verification | Automated cross-check with payment |
| | confirmation and expense report |

The described embodiment may provide a unified mechanism for pre-transactional control across procurement and accounts payable workflows. By enabling multi-modal capture of invoices and/or quotations, the proposed methods may validate spending before financial commitment, ensuring adherence to company policy and budget constraints. The automatic conversion of these documents into spend tokens and real-time expense reports may eliminate manual approvals and accelerate financial reconciliation.

Additionally, the ability to generate spend tokens in the absence of predefined policies may ensure seamless adoption for organizations without mature governance frameworks. This policy-agnostic operation may maintain real-time visibility, preserve intent tracking, and/or enable retrospective policy application as compliance frameworks evolve.

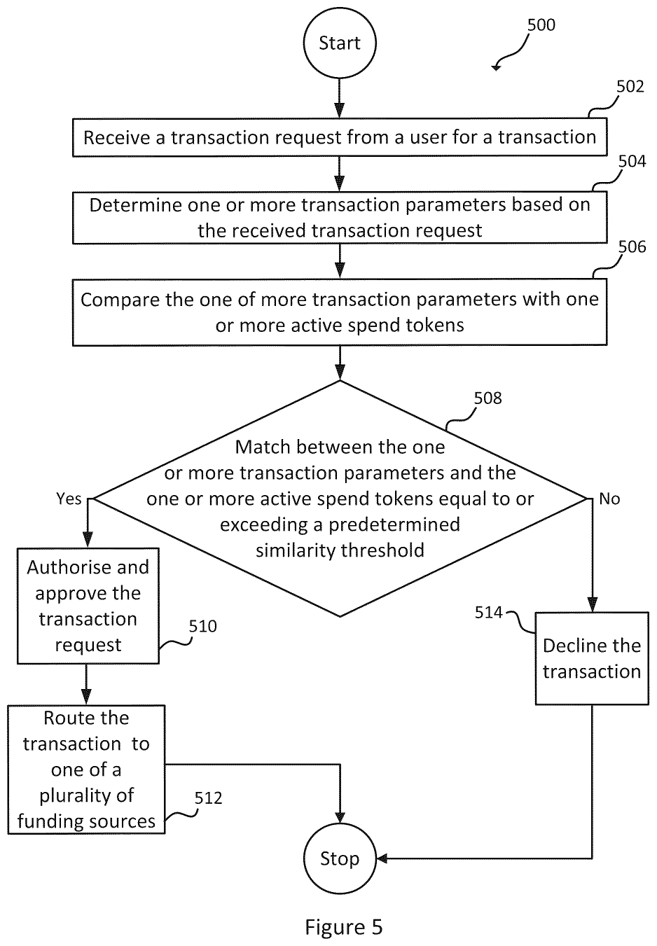

FIG. 5 is a flow diagram of a method 500 of managing a transaction according to an embodiment of the present disclosure. The method 500 comprises receiving a transaction request from a user for a transaction (step 502), determining one or more transaction parameters based on the received transaction request (step 504), comparing the one or more transaction parameters with one or more active spend tokens (step 506), determining if there is a match between the one or more transaction parameters and the one or more active spend tokens that is equal to or exceeding a predetermined similarity threshold (step 508). If the match equals or exceeds the predetermined similarity threshold, the method 500 proceeds to authorize and approve the transaction request (step 510) and routes the transaction to one of a plurality of funding sources (step 512). If the match does not equal or exceed the predetermined similarity threshold, the method 500 proceeds to decline the transaction (step 514). In an embodiment, the method 500 may operate at an issuer-level in a standard four-party card model comprising the cardholder, merchant, acquirer, and issuer. The transaction request may be an authorization request message (e.g., ISO 8583, ISO 20022). The one or more transaction parameters determined may be any one or more of: transaction value and currency; merchant name, merchant ID, and MCC; location or geocode; timestamp; and card and account identifiers. In one embodiment, the method may compare the determined one or more transaction parameters to active spend tokens which may be stored within an inference cache. Each spend token may include structured metadata defining permissible transaction boundaries, such as value limits, merchant category, location constraints, validity window, and associated Virtual Funding Account (VFA).

If a match between the one or more transaction parameters and one or more active spend tokens at or above a predetermined similarity threshold is achieved, the transaction request is authorised and approved automatically and the transaction is routed to the appropriate VFA. In an embodiment, a status of the spend token may also be updated to prevent duplicate use if applicable. In some embodiments, the authorisation and/or approval may occur within a standard network time constraint (e.g., 300 ms to 800 ms), to ensure compatibility with existing payment schemes.

If the match is below the predetermined similarity threshold, the transaction is declined in real-time. A user may be notified of such declining e.g., via a message, email, notification via a user interface of the application corresponding to the proposed method etc.

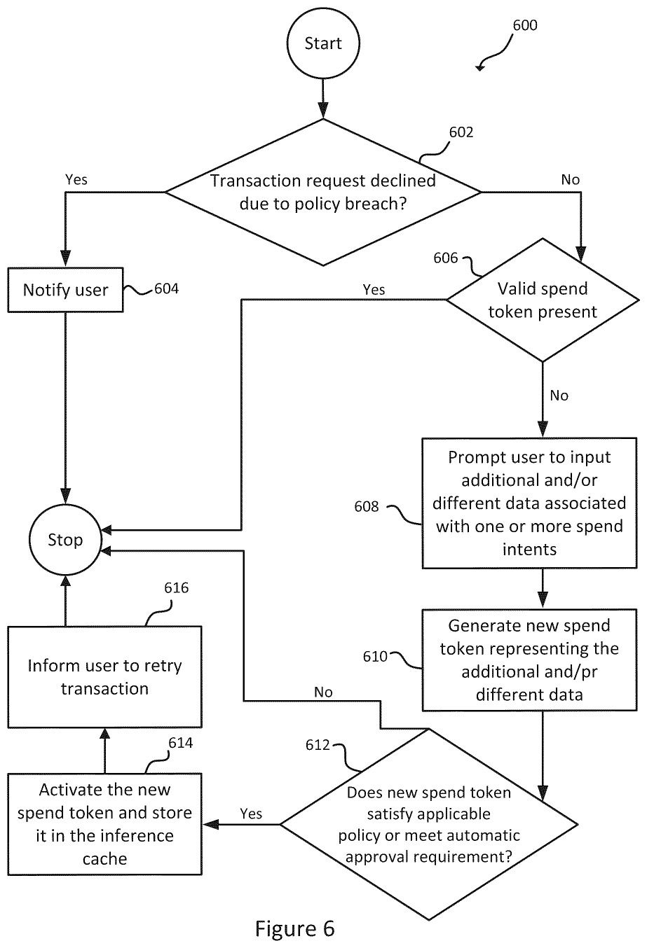

FIG. 6 is an exemplary post-decline asynchronous remediation workflow 600 according to an embodiment of the present disclosure. In an event where the transaction request is declined, a determination may be made as to whether the declining occurred due to breach of policy (step 602). If yes, the user is notified of the policy breach (step 604) and the method 600 ends. In some embodiments, the user may also be notified of the appropriate policy and/or the AI model may be updated to learn from the decline, for future enhanced user experience, pre-transaction intelligence and reduction of number of occurrences of transaction decline. If at step 602 it is determined that there was no policy breach, a determination of whether a valid active spend token was present is made (step 606). If there is a valid and active spend token and the transaction was declined not due to policy breach, the method 600 ends. However, if no valid and active spend token is found, the method 600 may proceed to send a notification is transmitted to the spender/user through any one or more of an application, chatbot, or user interface associated with the card program.

The notification may prompt the user to confirm or input additional and/or different data associated with one or more spend intents (step 608). In one embodiment notification may prompt the user to confirm or input additional and/or different data associated with the declined transaction. Such additional and/or different data may comprise any one or more of the user describing the business purpose of the spend intent, capturing one or more images of an invoice or fuel receipt, or recording a voice message. The Conversational AI Agent (e.g., shown as 408 in FIG. 4A) and Domain-Specific AI Agent (e.g., shown as 412 in FIG. 4A) may process this input to create a new spend token representing the clarified and/or approved spend intent (step 610).

The method 600 then determines if the newly created spend token satisfies applicable policy thresholds or meets an automated approval requirement (step 612). If yes, the newly created spend token is activated and stored in the inference cache (step 614), the spender/user may then be informed that the transaction can be re-tried under the new authorization parameters (step 616) and the method 600 ends. If no, the method 600 ends. If the user decides to retry the transaction, the method 500 may be initiated. In one embodiment, this post-decline method may occur within a few seconds, to maintain continuity of the user experience while adhering to network authorization timing requirements. In an embodiment, the post-decline asynchronous remediation workflow 600 does not delay the network response. Each decline-and-remediation event may contribute to an evolving dataset of approved and/or rejected spend intents. In some embodiments, the proposed methods may employ one or more machine learning models to infer recurring patterns of legitimate user spend behavior. Over time, the machine learning model(s) may automatically generates predictive and/or background spend tokens for common, policy-compliant activities, thereby reducing future transaction declines and increasing first-attempt success rates.

In various embodiments, the methods 500 and/or method 600 may be performed using the payment decision engine 314 of FIG. 3 or the approval module 422 of FIG. 4A. The payment decision engine 314 of FIG. 3 and/or the approval module 422 of FIG. 4A may accordingly allow user spend intent/user pre-transaction intelligence-based pre-transaction authorisation and management at the issuer level, irrespective of any specific issuer and may be either governed by corporate policy (for cards issued by the corporate entity) or user-defined policy (where the spender and funder is the same person or group of persons).

The proposed methods, systems and framework differ from conventional fraud management systems in one or more of the following ways: the proposed methods, systems and framework may follow a dynamic positive/whitelisting-based logic based on spend tokens instead of a negative/blacklisting-based logic, perform pre-transaction authorisation instead of post-transaction evaluation/authorisation; take as inputs one or more of user intent, policy context, AI inference instead of one or more of historical anomalies and/or aggregate behaviour; enables compliant, context-valid spending instead of being primarily focussed on blocking unauthorised activities; may output spend token authorisation instead of a fraud score or a risk flag; may adopt an adaptive intent-based and/or policy-based learning instead of a risk-based scoring. The proposed methods, systems and framework may work at an issuer authorisation layer that works on positive-logic and may complement existing fraud detection systems and methods and may operate within an issuer authorization path.

In various embodiments, a spend token may be a structured digital pre-transaction authorisation token representing a pre-approved and/or policy-compliant, and/or AI-predicted intent to spend. Each spend token may encapsulate one or more parameters selected from: intended transaction amount or range; applicable tax and currency; merchant identifier, MCC, or geofence; validity time window; associated VFA identifier; and policy or approval reference. Spend tokens may be: user-generated i.e., created when a spender declares intent directly (e.g., through text, voice input, or image capture) or AI-generated i.e., inferred automatically by domain-specific AI models trained on historical and/or policy data. In various embodiments, transactions may be approved if the one or more transaction parameters match an active spend token equal to or above a pre-defined similarity threshold. In some embodiments, spend intent(s) and corresponding spend token(s) may be generated just prior to a user/spender submitting a transaction request for a transaction. In other embodiments, the spend intent(s) and corresponding spend token(s) may be generated well in advance (e.g., a few days/weeks/months/years prior to the transaction).

Each spend token may act as a contextual authorization credential, allowing the issuer to determine, in real-time, whether the incoming transaction matches a pre-authorized spend intent of a user/spender. Transactions that match an active spend token may be approved instantly while those that do not may be declined and optionally a post-decline asynchronous remediation workflow may be triggered as described above, that enables rapid contextual recovery and continuous learning. The spend tokens may be generated directly by the spender, automatically by an AI model trained on prior transactions, or inferred from organization-specific policy data. In various embodiments, each spend token may be associated with a status. For single-use spend tokens, the status may be either “active” or “expired” (i.e., no longer usable following the single use). For spend tokens configured for recurrent use at a predetermined frequency for a predetermined period of time, the status may remain “active” until the end of the predetermined time while a count of recurrent use may be updated after each use. Once the count of recurrent use and predetermined period of time end, the status of such spend tokens may become “expired”, and no longer usable.

In various embodiments, a Virtual Funding Account (VFA) may be a logical or abstracted partition of a real funding source. Each VFA may correspond to one or more spend tokens and may define transaction rules and/or budgets for a specific business purpose (e.g., “Travel”, “Client Meals”, “Supplies” etc.). The proposed methods, systems and framework may dynamically create, modify and/or delete VFAs based on active spend tokens, thereby enabling multi-source routing under a single card credential.

In various embodiments, Pre-Transactional Intelligence (PTI) may refer to the process of capturing, interpreting and validating spend intent prior to a transaction. PTI may combine one or more of: natural-language understanding; AI-based policy reasoning; generation of structured spend tokens; and token-driven authorization. Such approach may convert human intent into structured, machine-verifiable authorization logic, executed in real-time.

In one or more embodiments, the present disclosure provides a pre-transactional authorization layer that may be configured to operate alongside existing fraud and/or payment systems and methods to determine legitimacy based on intent rather than anomaly. By generating and referencing spend tokens at the point of authorization, the proposed methods, systems and framework may achieve transaction-level control and/or policy compliance without reliance on new card issuance or static rules. Unlike existing fraud engines, which are configured to detect and block deviations from normal behaviour, the proposed methods, systems and framework may predict and enable valid user spend behaviour. Unlike conventional virtual card systems, the proposed methods, systems and framework may decouple authorization logic from credential generation. Such dual differentiation may provide a new category of transaction processing logic-intent-driven authorization—that may transform the payment card into a dynamic, context-aware, AI-enabled decision instrument.

The proposed context-aware, whitelist-driven authorization framework may complement existing payment and fraud systems and may perform real-time validation of spend intent through dynamically generated spend tokens, route approved transactions to appropriate Virtual Funding Accounts and engage asynchronous recovery/remediation workflows following transaction declines to maintain compliance and user experience.

The proposed disclosure may provide a shift from reactive fraud prevention to proactive spend enablement, establishing a new paradigm of intent-driven, policy-governed transaction authorization within the global payment network ecosystem.

By associating a single payment card with a plurality of funding sources/accounts or sub-accounts, improved budget control may be achieved than with exiting transaction management methods and systems. The present disclosure may allow modification of behaviour of a payment card by accounting for the context of spend rather than just a transaction value to then route the transaction to one of the plurality of funding sources despite the limitations imposed by the card number and/or payment network capabilities. Further, the present disclosure may allow modification of the behaviour of the existing payment rail to overcome or ameliorate issues with current behaviour of payment rails i.e., current payment rail behaviour allows for approval of a transaction request based on fund availability in a single funding source. The present disclosure may allow intercepting a transaction request on the payment rail, and making a decision based on multiple factors as described above and routing to one of a plurality of funding sources. Accordingly, the payment card behaviour may be modified from being a single-source instrument to a multi-source instrument.

The payment card of the present disclosure may be configurable using natural language to modify the manner of operation or approval of transactions e.g., by blocking transactions from specific vendor(s), allowing transactions within/from specific geographic location(s) or online alone etc. The payment card may also be used multiple times, and at each time, the corresponding transaction may be routed to the same or different funding source as described in the disclosure.

One or more embodiments of the present disclosure may allow for automatically routing a transaction to the most appropriate funding source as described above without a user having to manually select from one of a plurality of cards and therefore a funding source to which the card is linked or associated (e.g., from a plurality of cards associated with a digital card aggregator wallet). Further, the user may not be required to enter additional data (e.g., which account belonging to the user the transaction is to be routed to) at the time of submitting a transaction request and therefore no additional data, other than the transaction parameters mentioned elsewhere in the disclosure, may need to be sent through the payment rail(s) at the transaction time i.e., between submitting a transaction request and approval/decline of the transaction request. Accordingly, a more seamless user experience may be achieved while not impacting processing time of the transaction, by the present disclosure. The present disclosure may therefore route the transaction to one of a plurality of funding sources as described above without user intervention at the transaction time.

One or more embodiments of the present disclosure may provide dynamic transaction control (e.g., enabling approval or decline based on real-time intent validation rather than static limits), perpetual card architecture (e.g., eliminating the need for new virtual card issuance per transaction, multi-source routing (e.g., allowing a single payment credential to access multiple VFAs), closed feedback loop (e.g., transforming declined transactions into learning events that enhance future authorization accuracy) and/or infrastructure compatibility (e.g., fully interoperable with existing payment rails).

Many modifications will be apparent to those skilled in the art without departing from the scope of the present invention.

What is claimed is:

1. A method of managing a transaction, the method comprising:
receiving a transaction request from a user for a transaction;
determining one or more transaction parameters based on the received transaction request; and
routing the transaction to one of a plurality of funding sources based on a match between the determined one or more transaction parameters and one or more spend intents of the user.

2. The method of claim 1, wherein each of the one or more spend intents is a request or suggestion for a transaction submitted by the user prior to submitting the transaction request.

3. The method of claim 2, wherein routing the transaction to one of a plurality of funding sources based on the match between the determined one or more transaction parameters and one or more spend intents of the user further comprises determining one or more spend intent parameters of each of the one or more spend intents submitted by the user.

4. The method of claim 3, further comprising generating an account parameter set corresponding to each of the one or more spend intents in response to the determined one or more spend intent parameters satisfying an approval condition.

5. The method of claim 4, wherein for each generated account parameter set, a funding source is created.

6. The method of claim 1, wherein each of the one or more spend intents is submitted as an unstructured data by the user.

7. The method of claim 6, wherein determining the one or more spend intent parameters further comprises converting the unstructured data into structured data corresponding to the one or more transaction parameters associated with the transaction.

8. The method of claim 1, wherein the one or more transaction parameters comprises any one of: transaction value, applicable taxes, bank charges, payment network charges, merchant identity (merchant name, merchant identity number), merchant category code, location code, currency in which the payment was made, transaction value in native currency, time, date, terminal ID, terminal type, Invoice ID, Purchase Order ID, Product code, Product specification.

9. The method of claim 1, further comprising dynamically creating, modifying or deleting a number of the plurality of funding sources based on the one or more spend intents.

10. The method of claim 1, wherein the transaction request is made by the user using a payment card.

11. The method of claim 10, wherein the payment card is associated with each of the plurality of funding sources.

12. The method of claim 1, wherein the match is based on a weightage assigned to one or both of the user, funder.

13. The method of claim 12, wherein the weightage is dynamically updated.

14. The method of claim 1, further comprising routing the transaction to another one of the plurality of funding sources based on the match between the determined one or more transaction parameters and one or more spend intents of the user.

15. The method of claim 3, further comprising generating a spend token representing a pre-authorized payment equal to at least one of the one or more spend intent parameters of each of the one or more spend intents submitted by the user and satisfying an approval condition.

16. The method of claim 10, further comprising generating a spend token and mapping the spend token to at least one of the plurality of funding sources linked to the payment card.

17. The method of claim 15, wherein the spend token is configured to be active for a predetermined period of time.

18. The method of claim 1, further comprising performing a post-spend verification randomly or at predetermined intervals to maintain continuous compliance integrity.

19. The method of claim 1, further comprising autonomous pre-authorization wherein a spend token is generated based on a spend intent input by the user, without requiring policy validation.

20. The method of claim 1, wherein upon initiation of the transaction request at a point of sale, approving and routing the transaction to one of a plurality of funding sources based on a match between one or more of the transaction parameters and a spend token.
